(19) United States
(12) Patent Application Publication
(10) Pub. No.: US 2010/0282083 A1
(43) Pub. Date: Nov. 11, 2010

(54) Disinfecting air filter

(76) Inventor: John Edwards, Sarasota, FL (US)

Correspondence Address: Jackson Walker L.L.P.;c/o Mark A. Tidwell, Suite 1900, 1401 McKinney Street, Houston, TX, 77010, US

(21) Appl. No.: 12/006,414

(22) Filed: Jan. 2, 2008

Related U.S. Application Data
(60) Provisional application No. 60/878,187, filed on Jan. 3, 2007.
(60) Provisional application No. 60/922,011, filed on Apr. 6, 2007.

(51) Int. Cl. B03C 3/00; B01D 46/00; B03C 3/02; B03C 3/68

(52) U.S. Cl. 95/285; 55/524; 55/495; 96/55; 96/80; 96/25; 55/482

(57) ABSTRACT

Disclosed is an air purification filter with novel active media that attracts, migrates, binds, and destroys pathogens, including sub-micron pathogens, that are suspended in the air passing through the filter. These properties are incorporated in the micro-fibers comprising the active filter media by several novel methods. One embodiment uses polymers or solgel bound monomers of quaternary ammonium compounds as a biocide with both chemotactic and pathogen membrane lysing properties. Another embodiment uses biocide chemicals blended into the melt before filter fibers are extruded and electret dipole charged. The attracting-binding properties of the embodiments may be enhanced by including electropositive Boehmite nano-fiber strands in the active media, by coating a reversible voltage charged electro-conductive polymer, by the use of supplemental fusing and lysing chemicals, and by optional ion field charging of incoming pathogens.

This application claims priority from provisional filing 60/878,187 “ViraClean 2” filed Jan. 3, 2007, and provisional filing 60/922,011 “Pathogen Eradication Composition” filed Apr. 6, 2007.

### BACKGROUND OF THE INVENTION

This invention relates broadly to air cleaning devices that remove organic airborne pathogens of many types, including, viruses, bacteria, mycotoxin, fungi, spores, and allergen particles. More specifically, the invention relates to a method, composition, and apparatus, that attracts and binds pathogens to filtration material that is capable of chemically dismantling and destroying the pathogen.

There is a critical need to improve the air quality of inhabited areas by eliminating pathogens. Sale of consumer air purifiers have risen dramatically worldwide since Sep. 11, 2001, because of civilian concern for epidemic pathogens (Avian Virus, SARS, Influenza), and their bio-engineered military grade counterparts (Plague, Smallpox).

Air contains a mixture of particles, water vapor, and gases. A cubic foot of “clean” air will contain over a million particles; “dirty” air contains well over 30 million particles. Over 95% of the total weight of the particles in a cubic foot of air will be found in less than 1% of the total quantity of particles. Air particles between 1 to 10 microns will settle in still air, however, regular air currents can keep them airborne for substantial periods of time. (A human red blood cell is 7 microns in diameter.) Particles between 0.1 to 1.0 microns will eventually settle in perfectly still air, but remain airborne in normal conditions. Particles smaller than 0.1 microns behave like gas molecules and may remain airborne permanently. When inhaled, air particles between 8 to 10 microns are normally captured in the upper respiratory tract, particles between 2 to 8 microns are trapped in the conducting air ways to the lungs and are cleared through swallowing or coughing. Particles smaller than 2 microns are normally drawn into the lungs and may be retained there. These particles cause the greatest concern to health professionals and require HEPA grade filtration for adequate removal. Fungus debris and spores are generally larger than 2 microns. Intact bacteria are 0.3 to 40 microns large. Military grade Anthrax and Tuberculosis pathogens for airborne delivery are 1 to 5 microns in diameter. Tobacco smoke is made up of particles averaging 0.25 microns. Viruses are roughly 0.1 to 0.2 microns in diameter.

Electrostatic filtration technology is a mainstay of industrial effluent abatement. Very large, expensive, constantly maintained industrial systems are in use worldwide at industrial plants. They increase the electronegativity of the normally large effluent particles by strong field ionization. A negative corona is created via a negatively charged electrode in the contaminated airstream releasing electrons from its surface. The electrons move into the weaker electric field away from the cathode where they collide with and charge contaminant particles and chemical molecules, as well as with neutral gas molecules to form negative ions. The abundance of electrons in the corona is likely to dissociate passing O₂ molecule into its two atoms, generating higher transient ozone levels than would be created in a positive corona. Ozone production levels are dependent upon several variables, including the field strength used and the interelectrode distance. The charged contaminant particles are electrostatically migrated to large, positively charged, parallel collector plates; byproduct ozone is exhausted to the environment.

Currently popular residential air purifiers electrostatically attract contaminant particles to an accumulation plate that has a negative electrical charge. Periodically, the accumulation plates become covered with highly concentrated contamination and must be discarded or cleaned, presenting a new consumer health risk. Despite their popularity and claims for low energy consumption, such units aren't particularly effective air purifiers according to published reports from consumer product testing laboratories.

Consumer air purifiers tend to use the natural positive charge that large particles and molecules possess to attract them to the negatively charged collector plate. This charge may be enhanced by an entry ionizer. The negative collector generally minimizes the production of ozone by the devices, the concentration of which is regulated by governmental agencies because of its oxidizing toxicity to human lung material as well as to pathogens. Such consumer devices are less effective at removing smaller bacteria and viruses, which are inherently negatively charged.

HEPA filters are employed to remove submicron size particles from the air. HEPA (“High Efficiency Particulate Air”) filters, originally designed to remove and capture radioactive dust particles, are employed in a variety of environments, including hospital operating theaters, electronic manufacturing clean rooms, and nuclear power plants. More recently, HEPA filters have been adopted for use by consumers in portable air purifiers. The term “HEPA filter,” as used herein, refers to a filter that is capable of filtering out at least 99.97% of 0.3 micron diameter and larger particles. Ultra-Low Penetration Air (“ULPA”) refers to a filter that is capable of filtering out 99.999% of 0.12 micron diameter particles.

Conventional filter media relies upon impingement, impaction and diffusion for filter performance and is substantially lacking in electrostatic charge. Electrostatically augmented HEPA filters are described in U.S. Pat. No. 4,357,150 and U.S. Pat. No. 4,781,736. These patents teach the combination of HEPA filters electrostatically augmented with alternate plates between folds of filter media, connected to a high D.C. voltage source (e.g. 3 to 12 KV) and to ground. An ionizer section charges the particulate material entering the electrostatically enhanced HEPA filter. These filters are characterized by dramatic increases in the efficiency of the HEPA filter with a simultaneous reduction in the rate of pressure drop as the HEPA filter becomes dirty. Despite these benefits, acceptance of this technology has been slow because of serious drawbacks. These include the concern of high voltage discharge arching perforating the filter media between spacers, causing loss of filter integrity damage, new particulate matter being generated from arching holes, and the risk of fire.

Electret filter materials offer improved filtering performance over conventional filter materials without high voltage risk. Electret is a dielectric material that has a quasi-permanent electric charge, the electrostatic equivalent of a permanent magnet, generating internal and external electric fields. Unlike the transient induced polarization in a capacitor dielectric, dielectrics with electret properties exhibit long term charge storage performance. The presence of oriented dipoles in the electret filter media is believed to enhance filter performance by allowing the filter media to attract and retain charged and uncharged particles to be filtered. Electret filters provide an electrostatic charge at the filter fiber level, but they do not destroy pathogens, only block the large ones, while passing virus-size pathogens.

Research funded by the U.S. government under a DARPA grant led to U.S. Pat. No. 6,506,803 which describes the use of oil-in-water emulsions for inactivating microorganisms, including additives to enhance spore germination. While the use of numerous biocides are claimed, including cationic halides, the claims and the research address anti-microbial oil-in-water emulsions, including the use of toxic phosphates and organic solvents diluted to minimize toxicity. These emulsions would be disbursed via liquids, sprays, or mists, not biocides permanently bound to HEPA air filtration media. That work does not anticipate or address the bonding of such emulsions, nor cationic halide monomers or polymers, to such filter media micro-fibers, operating as an integral module of a systemized chemotactic-electrostatic method, composition, and apparatus.

U.S. Pat. Nos. 5,762,797 and 6,171,496 by Patil et al describe the construction of cartridges for water filtration with optional impregnation of Microban® antimicrobial agent in the yarn or hollow fiber membranes. These continuation-in-part patents do not address air purification, nor the use of water soluble anti-microbial agents in such methods (Microban® chemical is water in-soluble), nor the permanent bonding of such agents to HEPA type high efficiency air filtration media.

### BRIEF SUMMARY OF THE INVENTION

The present invention is an air purification filter with novel Active filter media that attracts, migrates, binds, and destroys pathogens, regardless of their size, as these pathogens that are suspended in breathable air pass through the filter. Filter screens lacking these novel advantages are used extensively today in conventional real estate HVAC (Heating, Ventilation, Air Conditioning) in-line air handling systems.

The invention destroys suspended pathogens in the air of enclosures that are still occupied by people, plants and livestock while they are breathing the air.

More particularly, this invention separates suspended pathogens by migrating them out of the airstream to the filter media surface, binds them there, then chemically ruptures their cellular enclosures, spilling the organic contents to destroy the pathogen. These novel properties are incorporated in the micro-fibers comprising HEPA or ULPA filter media, or in lower MERV rated conventional air purification filters, by several novel methods.

Accordingly, it is a primary object of the present invention to provide a new and improved method, compositions, and apparatus for destroying pathogens thereby.

It is a further object of this invention to permit operation of the method, composition, and apparatus while people, pets, plants, or livestock may be present in the air being treated.

It is a further object of this invention to improve breathable air and in so doing, use no ingredients or residue that could be harmful to the environment.

It is a further object of this invention to separate and migrate suspended pathogens to a filter media that may be economically disposable.

It is a further object of this invention to eradicate all migrated pathogens by structural dissociation of their cellular makeup, converting them to harmless protein fragments.

It is a further object of this invention to provide options to amplify the attraction, migration, binding, and destruction features by several novel methods to improve overall pathogen lethality.

It is a further object of this invention to provide several apparata embodiments for carrying out methods that achieve the foregoing objects, embodiments which are relatively simple in construction and effective in operation.

It is a further object of this invention to provide such methods, composition, and apparatus that can be used easily in either a portable configuration, or permanently incorporated into the conventional air handling systems of industrial and residential buildings.

It is a further object of this invention to provide such methods, compositions, and apparata that can be permanently incorporated into the air handling systems of transportation vehicles such as aircraft, trains, and buses.

It is a further object of this invention to provide methods, compositions, and apparatus that can be permanently incorporated into the air waste stream of health care and other facilities in order to minimize hazardous pathogen-related emissions to the environment.

These and other objects will be made manifest when considering the following detailed specification when taken in conjunction with the appended drawing figures.

### BRIEF DESCRIPTION OF THE DRAWINGS

FIG. 1 is a drawing of one embodiment of the invention using biocide coated polymeric micro-fibers in a non-woven HEPA active filter media mat contained in an enclosed housing.

FIG. 2 is a drawing of a second embodiment using biocide coating over electro-conductive polymer coated HEPA micro-fiber active media with a voltage generator attached.

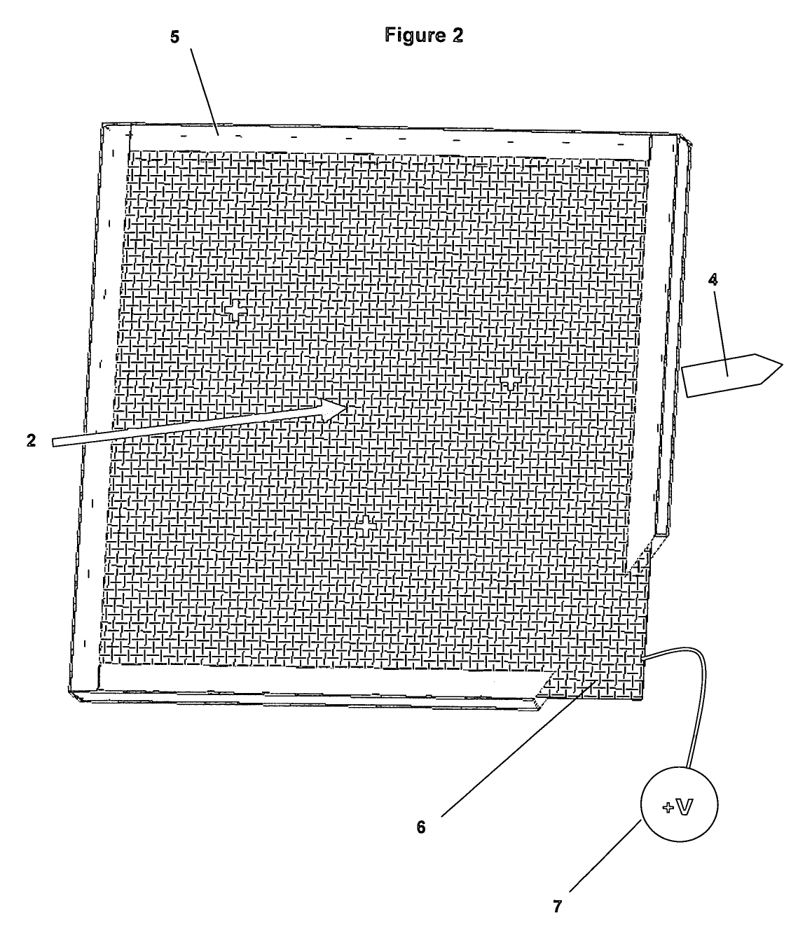

FIG. 3 is a drawing showing ion field generator wires installed at the upstream entrance to the air handling duct housing the biocide coated active filter media cartridges of this invention.

FIG. 4 is a drawing showing a cutaway of the type of multi-layer filter cartridge of this invention that is installed in an HVAC duct, each layer comprised of one or more biocide-impregnated, non-woven HEPA active media mats.

### DETAILED DESCRIPTION OF THE INVENTION

The present invention provides a purification method, composition, and apparatus wherein pathogens suspended in breathable air passing through an air purification filter are migrated to the novel Active media comprising the filter where they are bound to the Active media, then destroyed.

Fibers that comprise the active filter media of this invention chemotactically attract, then bind the pathogens. A biocide in the fiber's matrix ruptures the pathogen membrane, spilling the cellular contents to destroy the pathogen. These properties are incorporated in the micro-fibers comprising a HEPA or ULPA media, or filters of lower MERV (Minimum Efficiency Reporting Value) ratings, by several novel methods.

HEPA and ULPA filters are typically constructed of different types of passive micro-fibers laid together into a nonwoven microfibrous mat with an inherently low porosity, (small “sieve size”). This sieve size is the basis for size exclusion filtering of contaminants from the airstream. This micron-particle, passive filter media is usually protected by a prefilter (dust layer) to remove larger particles from the incoming airstream. In general, the smaller the fiber diameter the smaller the filter media sieve size. Bulk glass micro-fibers are available in diameters as small as 0.3 microns, but they have low strength and temperature resistance. Quartz fibers have 0.5 micron diameters; the smallest stainless steel fiber diameter (for high temperature applications) is about 2 microns. “Spunbond” (depositing extruded, spun filaments onto a collecting belt in a uniform random manner followed by bonding the fibers), or “Melt Blown” (hot melt processable polymer extruded through a die with a linear array of orifices) can have diameters of about 1.0 to 15 micrometers, preferably about 3 microns. The mat is pleated into an accordion fold to allow a large amount of surface area within the filter housing. The ultra-fine fibers comprising the polymer fiber web may be polypropylene, polyester, polyamide, polyvinyl chloride, polymethylmethacrylate, polyethylene, polyurethane, nylon, or rayon.

The present invention uses the natural electrostatic charge on pathogens to help separate them out of the moving air stream, migrating them to remain at the biocide filter screen surface even if their diameters are well below the filter media sieve size. Most suspended contaminants have a natural electrostatic charge present on them. Large macromolecules generally have a natural positive charge. For example, dust particles and many allergens tend to be positively charged, which helps keep these large particles suspended in air. Small microorganism particles typically have a negative charge on them, including most pathogens. Bacteria and their fragments are negatively charged due to their cell wall chemistry. Gram negative bacteria contain negatively charged —COO* groups associated with proteins and lipopolysaccharides in their cell walls. Gram-negative bacterial endotoxins (pyrogens) are also negatively charged as are viruses and most colloids.

The biocide coatings on the active filter media of this invention attract, bind, and kill pathogens. The attraction-binding-killing properties may be manifested in one chemical compound, or in several chemicals acting together. Additionally, the biocide may be coated onto the filter media fibers or it may be imbedded and disbursed throughout the substrate material from which the fibers are drawn. Since this filter media is protecting air to be breathed by humans and livestock, it is important that the biocides not readily leach into the airstream being breathed. If they do gradually leach or deteriorate over time, it is important that the biocides and any derivatives have minimal toxicity.

One embodiment of, this invention uses a biocide with both chemotactic and membrane lysing properties that is coated onto the micro-filters either before or after they are matted. Quaternary ammonium compounds are ideally suited to this method.

Quaternary ammonium cations, (hereinafter referred to as “QUATS”), are the dominant commercial example of cationic surfactants. A QUAT is any of a group of compounds in which a central nitrogen atom is joined to four organic radicals and one acid radical. They are polyatomic ions of the structure NR₄⁺ where R′s are alkyl, aryl, or alkylaryl groups of from 6 to 26 carbon atoms, which assemble in a quaternary structure, with a counter halogen ion (chlorine, bromine, fluorine, iodine). Therefore, they are permanently positively charged, ionic compounds (surface active cations), independent of the pH of their solution, essentially surfactants that are salts of cations with an anion.

QUATS were found to exhibit anti-microbial activity in 1916 and were described by Domagk et al. in 1935. In an anti-microbial application the positively charged quaternary cationic group has a very strong affinity for the negatively charged surfaces of microorganisms to which the group binds electrostatically. If one of the replacement radicals is a normal, primary alkyl of 8-18 carbon atoms chain length and the others are only 1-3 carbon atoms, the QUAT compound is water soluble, surface active, and strongly biocidal. Compounds with two or more substituents radicals of higher alkyls are water insoluble and of moderate biocidal strength.

Once attached to the pathogen surface the negatively charged hydrophobic halide ion proceeds to reduce enzyme activities of the pathogen membrane proteins, altering the membrane protein activities, lysing the pathogen membrane via phospholipid bilayer disruption, thereby rupturing it, spilling the cellular contents, and killing the pathogen. QUATS have excellent anti-microbial activity against Gram-positive bacteria, such as Staphylococcus aureus, as well as anti-Gram negative bacteria, such as Escherichia coli. Furthermore, QUATS are effective in repressing the proliferation of fungi and lipophilic viruses, such as herpes simplex, influenza and adeno virus.

The QUATS most suitable for this embodiment, but not limited hereby, include the Group I Quaternary ammonium compounds, (to include siliconized and non-siliconized compounds), and the Group II ADBAC's (Alkyl Dimethyl Benzyl Ammonium Chloride) with their benzene rings. Recently the U.S. Environmental Protection Agency approved broad application of the ADBAC molecules for disinfection applications because of their joint efficacy with minimal toxicity to humans, plants, and animals.

Although the electron volt potential of a QUAT molecule is individually and collectively low when compared to the high kilovolts used in electrostatic precipitation applications, the local electrostatic potential of QUATS at the short, typically 0.5 micron distances within a HEPA media “sieve size” has a sufficient field strength to link up with the cell surface charges of sub-micron diameter pathogens.

We have found that inclusion of a super spreading agent facilitates thorough coating of the polymeric/monomeric QUAT biocide over fiber media polymer and helps deliver the QUAT carrier-payload through the hydrophobic-lipophilic surface tensions of the pathogen cell capsule and porous cell wall onto the targeted membrane. Super spreading agents used include, but are not limited hereby, to the group consisting of the organosilicone wetting agents, the fluoro-organic wetting agents, and are more preferably selected from the group of low volatile organic content acetylenic diols, and mixtures thereof. The super low molecular weight nonionic silicon polyether surfactant (e.g. Dow Corning Q2-5211) has been shown to be an effective spreading agent of this invention, as has acetylenic diol, nonionic, ultra-low VOC, low foaming, super wetting agent (e.g. Air Products DYNOL 64).

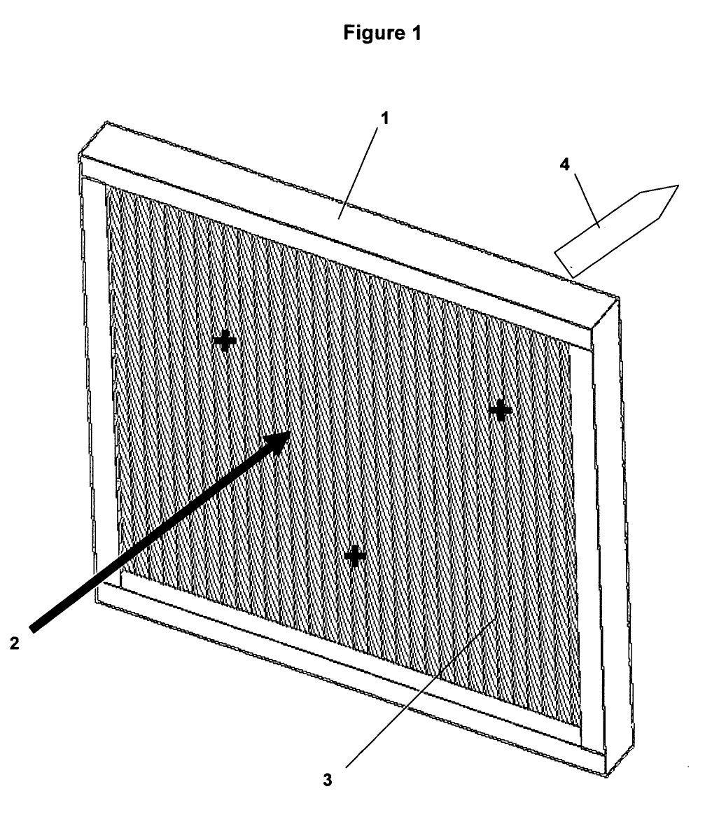

FIG. 1 is a drawing showing a filter cartridge embodiment of this invention using biocide-coated inorganic, nonwoven filter media in a cartridge housing. Contaminated air 2 is drawn into the inlet of filter cartridge 1 by a fan (not shown). The nonwoven fibers of filter media 3 are coated with a QUAT, which consists of positively charged, surface active, QUAT monomer or polymer. The surface of each fiber is therefore positively charged, conveying an overall net positive charge to the micro-level surface of each fiber comprising active filter media mat 3. As negatively charged pathogens in the air stream pass through the filter media and near the oppositely charged fibers they are electrostatically attracted and migrate to the chemically coated micro-fiber surfaces. There they are held in place by both size exclusion and electrostatic attraction, essentially maximizing their dwell time while the QUAT coating reduces the enzyme activities of pathogen membrane proteins until membrane lysis, rupture of the cellular envelope, and destruction of the pathogen. Purified air 4 exits the filter cartridge.

A second embodiment uses a combination of cooperative chemicals to attract, bind, and destroy the pathogen. A fusing chemical binds a membrane lysing chemical to the pathogen cell surface. The fusing and lysing agents act together to reduce bacterial clumping, degrade the outer pathogen capsule, penetrate the porous cell wall, and degrade the cell membrane by disrupting the phospholipids and sterols comprising the pathogen capsule and inner cell membrane. The fusing and lysing chemicals may be blended into the filter micro-fiber melt before filter fibers are extruded or blown. Alternatively, these may be coated onto the fibers or the assembled mat. Specimen fusing agents for this embodiment include, but are not limited hereby, to Triton X-100 (a non-ionic surfactant) and Nonoxynol 9 (a non-ionic amphiphile surfactant). Specimen lysing agents for this embodiment include, but are not limited hereby, to TBP (tri-n-butyl phosphate), NaNBBS (an aromatic sulfonate), NaBMGS (a glycol sulfate), and calcium hypochlorite (a chlorine based oxidant).

Any of the foregoing methods may be followed by dipole charging to convey electret properties to micro-fibers of the matted media. Electret filter materials for HEPA filters of this invention are made by a variety of known techniques including the use of AC corona or DC corona discharge and combinations thereof to impart permanent dipoles to the web. In one technique the drawn fibers are collected on a rotating drum or moving belt using a moderate vacuum, then the fiber web is corona treated to impart charge pair dipoles to the fibers.

Quartz, silicon dioxide, and synthetic polymers are electret materials. The electret melt blown polymer fiber web layer(s) comprising the HEPA filter of this invention can be made from a variety of polymeric materials, including polypropylene, polyester, polyamide, polyvinyl chloride, polymethylmethacrylate, and polyethylene. Polypropylene is among the more preferred polymeric materials. In 1985 AT&T Bell Labs discovered a method to induce a positive charge to fluoropolymers polyfluoroethylenepropylene (FEP) and polytetrafluoroethylene (PTFE) by injecting ions into the material at a mean depth greater than 4 microns below the surface. This method conveys internal positive charge stability on the material of greater than 100 years at room temperature.

FIG. 1 may also be interpreted as showing a filter cartridge embodiment of this invention using biocide chemicals coated onto inorganic electret filter media. Contaminated air 2 is drawn into the inlet of filter cartridge 1 by a fan (not shown). Carried by the moving air, many of the suspended contaminants, including large pathogens, impact the biocide coated surface on the fibers comprising the filter media 3. The electrostatically charged pathogens are attracted to, and held by the electrostatic field radiating out from each electret fiber through its biocide matrix coating. The bound pathogens are destroyed by the lysing properties of the chemical biocide coating. Purified air 4 exits the filter cartridge.

QUATS may be used as the biocide chemical coated over electret charged fibers. However, since both the chemical compound and the micro-fiber are charged, electrical neutralization will occur at the charged fiber surface if the QUAT is directly coated without an intermediate diaelectric coating. Any given electret fiber typically has a positive charge on one side of the fiber and a negative dipole charge on the opposite side. These dual charges of electrets at different surface locations give conventional electrets much of their attraction and binding features. The cationic charge of the QUAT compound may be reduced or cancelled when in the vicinity of the electret fiber's negative dipole, and will be reinforced when located in the vicinity of the fiber's opposite positive dipole side, enhancing cationic field strength at the fiber and at the macro-matted media level. On an individual fiber, only a thin polymeric dielectric interface coating can be used to insulate the respective field charges to avoid excessively increasing micro-fiber diameter with a consequential increase in filter porosity. Such an additional processing step for insulation coating increases the cost of a disposable, pathogen-eradicating HEPA filter.

The attracting-binding properties of the foregoing embodiments may be enhanced by: (a) coating a reversible, moderate-voltage charged electro-conductive polymer onto the fibers, or (b) by mixing electropositive nano-fiber strands with the original filter micro-fibers during matting, or (c) by adding chemical fusing agents as a fiber coating, and/or (d) by ion field charging of incoming pathogens.

A positive charge may be added to the HEPA media by constructing it with a current carrying metal mesh imbedded between layers of HEPA fiber mat. Such a current carrying mat screen may typically be constructed of fine mesh aluminum or stainless steel. This is an expensive improvement to radiate a moderate voltage within a disposable HEPA filter, in order to avoid kilovolt arching risks. Seamless electrical conductivity can be imparted to the filter media instead by mixing electro-conductive polymers into the original filter media melt, by coating the filter fibers as they are blown or extruded, or by coating the assembled mat. Electro-conductive polymer coatings are commercially available (e.g. ECX® from Mitsubishi Chemical). Highly electro-conductive polymer compositions, originally based on the dispersion of conductive filler particulates and organotitanates in thermoplastics, are recently being displaced by melt processable polyaniline Inherently Conductive Polymer (ICP's). These state-of-the-art materials (Nobel Prize in 2000), are usable for composite blending and coatings, and are being incorporated into radio-frequency identification tags, solar cells, and smart materials. Voltage on the current carrying HEPA media with this electro-conductive coating can be programmed to reverse automatically on a scheduled cycle to repel accumulated non-pathogenic material and periodically attract oppositely charged contaminants, reducing dust accumulation on the filter media, and thereby extending its useful service life.

An aluminum oxide hydrate named Boehmite has natural high electropositive attributes and may be mixed with the original HEPA micro-fibers during matting, without increasing filter “sieve size”. These nano-fiber strands are typically 2 nm in diameter and 100 nm long, collectively presenting a very large surface area of their powerful electrostatic attraction for viruses, bacteria, protozoa, and negatively charged organic and inorganic macromolecules. Aluminum oxides and their hydrates possess polymorphism, (different crystalline lattice packing and crystallite bonds) that cause their deviation from stoichiometry. These oxides are amphoteric (behave as solid acids and solid bases). The aluminum oxide Al₂O₃ form is called Corundum. The aluminum hydroxide Gibbsite stage Al(OH)₃ with refractive index of 1.55 and isoelectric point of 9.2, changes to 1.65 and 9.45 respectively in the oxyhydroxide AlO(OH) stage which is called Boehmite. One U.S. company has attempted to patent certain methods of using the very strong isoelectric attractive properties of Boehmite for microfiltration of negatively charged molecules. (See U.S. patent application US 2003/0127393 A1, “Nanonsize Electropositive Fibrous Adsorbent”.) In our research we have produced super-hydrated Boehmite from commercially available Gibbsite aluminum oxide particles via boiling for 30 minutes at 100 degrees Centigrade, instead of using complicated production processes based on electro-explosion of wire from microsecond electrical discharge pulses. In this invention the Boehmite nano-particles may be biocide coated while the filter micro-fibers are being coated.

Binding for maximum dwell time of pathogens may also be amplified by using a chemical fusing agent in the coating. Several excellent fusing agents, generally in the surfactants category, are available and have been admixed with coatings of this invention to improve binding of the pathogen to the biocide micro-fiber, including, but not limited to, Triton X-100 (a non-ionic surfactant) and Nonoxynol 9 (a non-ionic amphiphile surfactant).

The natural charge on incoming pathogens can also be artificially strengthened to improve the effectiveness of the method of this invention. The ability to place or alter an electrostatic charge on a suspended particle is directly related to its total surface area and its total mass. Therefore, it is more difficult to alter or increase the natural electrostatic charge on a smaller contaminant particle than on a larger particle. The natural positive charge of larger particles and macromolecules can be reversed to net electronegativity by charging them with electrons produced in a negative corona discharge.

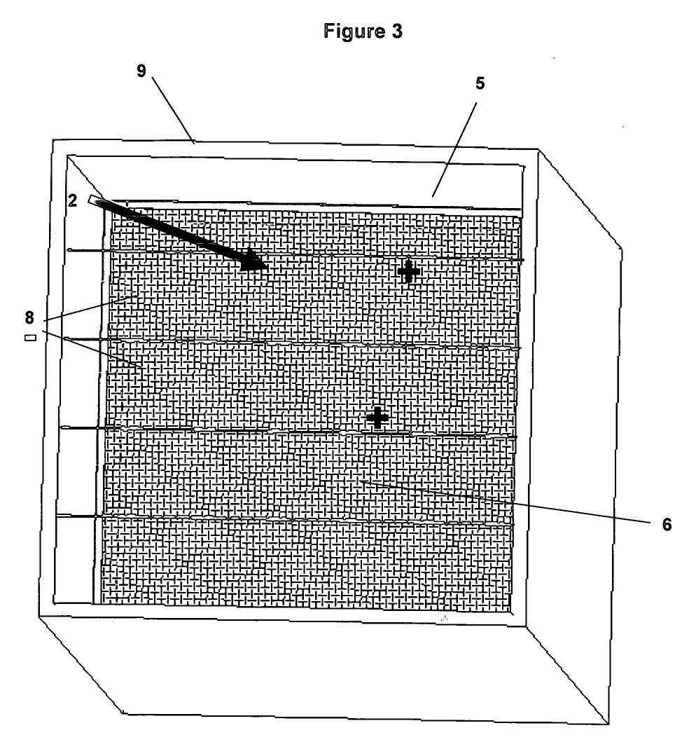

Ionic charging of incoming contaminants in electrostatic precipitation devices is prior art. However, enhancing the natural negative cell surface charge of pathogens to amplify interaction with active filter media, charged at the micron-fiber level by QUAT monomers/polymer coatings, is a new discovery. FIG. 3 is a drawing of yet another embodiment showing ion field generator wires 8 at the upstream entrance of an air handling duct 9 that houses the HEPA filter cartridge 5. DC voltage in the neighborhood of −3000 volts applied at very low current to the ion field generator wires 8, is adequate for negative ionization at 9 without significant ozone production. Electrons “boil off” the wires and by diffusion collide with, or may attach to, incoming pathogens, further strengthening their natural net electronegativity. The larger, positively charged surfaces of inorganic particles attract and bind colliding electrons from the negative corona and negative ions created in the interelectrode space, tending to neutralize or reverse their natural positive surface charge. Charged pathogens are migrated to and bound-destroyed by the active filter media 5. Purified air exits the filter cartridge.

The anti-microbial properties of QUAT's are well known in the art; but the monomers tend to leach away too quickly from the substrate on which they have been placed to protect. One of our research goals has been to imbue the QUAT molecules with durable, reliable, long-lasting, non-leaching properties on multiple surfaces.

Strengthened biocide-to-fiber bonding and an increase of total biocide-available active surface area can be achieved by using polymerized biocide. Group I and Group II QUAT monomers in polymerized form have increased total surface area exposure of the surface active cations without degrading their pathogen attraction and binding features, or their halide counter-ion destructive features. Nano-layered sol gel coating can also provide an immobilized matrix carrier to strengthen biocide-to-fiber bonding, increase total biocide active surface area, and reduce HEPA media sieve size in the process.

Proprietary QUAT polymerization processes, together with the resulting biocide-to-surface bonding improvements of such polymers over their monomer form, have been covered in this inventor's prior provisional patent applications cited earlier. For example, Group QUAT monomer silane 3-(trimethoxysilyl)propyl dimethyl octadecyl ammonium chloride (CAS # 27668-52-6), is a commonly used siloxane antimicrobial patented by Dow Chemical in 1992 as a rinse cycle additive. Our research shows that polymerization of this organosilicone QUAT using an admixture of 66% distilled water, 32% QUAT, and 2% ammonium hydroxide catalyst, precipitates a polymerized, larger repeating molecule that adheres well to HEPA micro-fibers once dried, while preserving QUAT properties.

Sol gel is a colloidal suspension of silica particles gelled to form a three dimensional, solid porous matrix several hundred nanometers or greater in thickness. The coating is prepared by a hydrolysis-condensation-polymerization reaction of actives (chemical molecules or biological payloads) blended with suitable monomers. The resulting coating is a high thermal stability, chemically and photochemically inert, fixed porous inorganic silica glass network matrix in which the actives are entrapped but still functional, remaining exposed within the porous three dimensional dried gel matrix. The porous layer thickness can be increased by multiple coats.

We have discovered that such a sol gel colloidal suspension coating works well as a fixed, porous matrix to support and prevent leaching of a QUAT monomer, (or polymer), carrying the attraction, binding, and destruction vectors, while simultaneously improving HEPA filter media “sieve size”. When such a sol gel coating is properly compounded, applied and dried, it provides a stable, high surface area, three dimensional dry carrier structure. The biocide molecules are physically entrapped in the interstitial cavities of the three dimension matrix network. This matrix permits small pathogens to move freely in and out of the porous matrix to react with the entrapped biocide, providing a stable, “breathable” surface area that is hundreds of times greater than that of using only the filter fiber's natural two dimensional curved surface alone. Unexpectedly, coating a matted HEPA fiber media with QUAT monomer impregnated sol gel, instead of coating the raw fibers before matting, reduces the HEPA media sieve size, giving the media more efficient size exclusion properties for small pathogens, while reducing the physical distance that the electrostatic fields must bridge to interact charges on passing sub-micron pathogens with the chemotactic coated micro-fiber surface.

Our experiments with Group II QUATS using sodium hydroxide catalyst have yielded sol gel coat monomers and polymer precipitates. Three ADBAC QUATS were separately diluted with distilled water then each admixed with sodium silicate solution containing 14% sodium hydroxide and 27% silicon dioxide to a clear liquid solution. The ADBAC's used were CAS# 68424-85-1 (Alkyl (60% C14, 25% C12, 15% C16) dimethylbenzyl ammonium chloride), CAS# 121-54-0 (2-(2-(p-(diisobutyl) phenoxy)ethoxy)ethyl dimethyl ammonium chloride), and CAS# 139-07-1 (Dodecyl dimethyl benzyl ammonium chloride). The resulting gel spreads and dries to a monomer payload sol gel coat on fiber and on aluminum sheet. Hydrolysis of the intermediate solution and precipitation occur upon adding sodium hydroxide and methanol solvent. The condensed polymers may be recovered with removal of solvents, then dried, powdered, and admixed back into proprietary biocide coatings on HEPA micro-fibers or coated on the assembled filter media mat.

Among the uses for the novel filter media of this invention are industrial face masks, ASHRAE filters, HEPA portable and HVAC filters, HEPA vacuum filter bags, and ULPA filters.

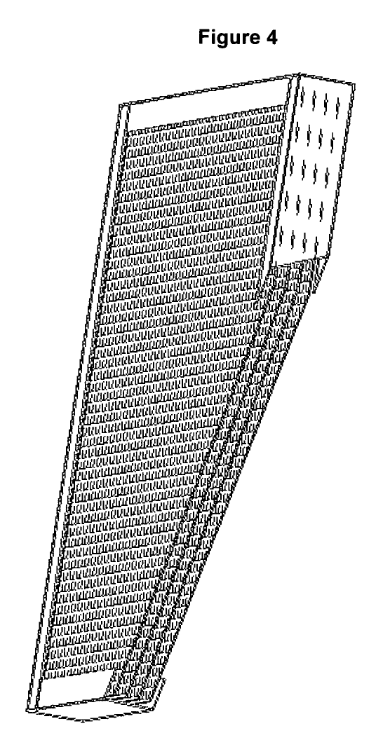

For HVAC applications the invention can be in the form of an array of large dimension dismantling filter cartridges, for installation into either portable apparatus, or into air flow ducts in fixed HVAC (Heating, Ventilation, Air Conditioning) systems. There are many simple solutions to the flow rate limits and pressure drop metrics of using such fine sieve size HEPA's in real estate HVAC systems. Cartridges composed of multiple dismantling screens are suitable for large scale placement in the pathogenic waste air stream of health care and other facilities. Contaminated airflow is purified in each filter cartridge as the electrostatically charged media attracts, migrates, binds, and dismantles pathogens suspended in the passing air. FIG. 4 is a drawing showing a cutaway of the multiple layer filter cartridge installed in an HVAC enclosure, each cartridge comprised of one or more biocide-impregnated active filter media mats of this invention.

What is claimed is:

1. A method for purifying air, said method comprising the steps of:
a. directing an air stream carrying contaminants through a novel active filter media;
b. comprised of elements having chemotactic-electrostatic properties impregnated or coated that interact with the electrostatic charge of passing pathogens, causing the pathogens to migrate to and bind to the filter elements for a maximum dwell time there;
c. such elements having biocide properties that rupture the membrane of the bound pathogens, spilling their cellular contents, thereby destroying the pathogens;
d. optionally altering the strength, polarity, or both of a contaminant's natural electrostatic charge to enhance the efficacy;
e. optionally altering the strength, polarity, or both of said filter media elements' electrostatic attracting charge to enhance attraction, migration, binding, and destruction of passing pathogens.

2. A composition comprising:
a. filter media elements constructed of conventional materials that have been coated or blended with organic or inorganic compounds to create an electrostatic attraction field on the element, such compounds to include the class of quaternary ammonium compounds, non-ionic surfactants, electret charged filter fibers, Boehmite nano-fibers, and electro-conductive polymers;
b. biocide chemical compounds that have been blended or coated on the filter elements to include quaternary ammonium compounds and phospholipid lysing chemicals;
c. polymerization of said biocide chemical compounds to increase biocide-to-filter-element bonding strength and total active surface area;
d. a super spreading agent to improve coating of the electrostatic and biocide chemical compounds onto the filter elements, and to improve accessibility of said bound chemical compounds to the migrated pathogen's membrane;
e. optional inclusion of a three dimensional sol gel matrix network coating on said filter elements to provide a “breathable” larger area of the electrostatic-biocidal matrix, while reducing the overall sieve size of the assembled size exclusion active filter media mat;
f. optional inclusion in the composition of dielectric compounds between layers of charged surfaces on the filter media elements, where such charges could cancel one another if an electron path existed between the charged surfaces.

3. An air purifier apparatus comprising:
a. filter cartridge containing active filter media for insertion into the filter holder of portable air purifiers and conventional HVAC in-line air handling systems;
b. such filter cartridge having an outer frame housing one or more internal active filter media units;
c. said internal active filter media units optimally fabricated as non-woven fiber mats comprised of fiber elements that have been coated with a biocide such as polymerized quaternary ammonium compound;
d. said fiber elements optionally including an electro-conductive-polymer coating layer beneath the biocide outer layer, with a diaelectric chemical compound layer separating the outer layer and the electro-conductive-polymer layer beneath it.

4. The method of claim 1, wherein the chemicals of the biocide coating act to attract, bind, and rupture the contaminant cell surface.

5. The method of claim 1, wherein the chemicals comprising the biocide coating over non-electret filter material may be polymerized, or non-polymerized, members of the quaternary ammonium family of compounds.

6. The method of claim 1, wherein the chemicals comprising the biocide coating over electret filter material include but are not limited to phosphate based solvents that disrupt the phospholipids and sterols comprising the pathogen capsule and inner cell membrane.

7. The method of claim 1, wherein the charge on the electrostatic biocide coating over a non-electret micro-fiber element, or the charge of an electret micro-fiber beneath an uncharged biocide coating, is sufficient to attract the natural, opposite electrostatic charge of passing organic contaminants, migrating them to the biocide surface, thereby significantly increasing the “dwell time” of the contaminant being bound to the biocide site of pathogen destruction.

8. The apparatus of claim 3, wherein contaminants suspended in the air entering the filter cartridge may optionally be electrically excited by an ion generation field that creates, amplifies, or changes the polarity of the contaminant's natural electronegative or electropositive charge via the production and attachment of electrons, negative ions, and/or positive ions.

9. The apparatus of claim 3, wherein the current carrying filter elements may be constructed of a material such as aluminum, copper, brass, tungsten, nickelized steel, or electro-conductive polymer.

10. The apparatus of claim 3, wherein the optional intermediate dielectric layer between the outer biocide layer and the current carrying filter element may be tetrafluoroethylene.

11. The apparatus of claim 3 wherein an external voltage applied to the current carrying filter elements is sufficient to attract the natural or artificial electrostatic charge on the surface of pathogens entering the apparatus, causing them to migrate to and remain at the biocide surface coating until their destruction is complete.

12. The apparatus of claim 3, wherein the voltages used in an optional ion field generator may be reversed at time intervals, either selectively or automatically, in order to enhance capture of larger or smaller contaminant particles with naturally weak or missing electrostatic surface charges.

13. The apparatus of claim 3, wherein the voltages applied to the current carrying filter elements may be reversed at time intervals, either selectively or automatically, in order to enhance capture of contaminant particles with naturally weak electrostatic surface charges or charges of opposite polarity.

14. The apparatus of claim 3, wherein the voltages applied to the current carrying filter elements may be reversed at time intervals, either selectively or automatically, in order to clean the biocide dismantling surface by electrostatically repelling any charged debris that may have accumulated on it.

15. The apparatus of claim 3, wherein multiple biocide filter screens of this invention are arrayed adjacent to one another in an air handling duct, with each filter cartridge containing one or more active filter media mats, comprised of the materials and chemicals of this invention.
